(19) United States
(12) Patent Application Publication
(10) Pub. No.: US 2026/0221129 A1
(43) Pub. Date: Jul. 30, 2026

(54) VEHICULAR VOICE PERSONALIZATION SYSTEM

(71) Applicant: Magna Electronics Inc., Auburn Hills, MI (US)

(72) Inventor: Patrick A. Miller, Saginaw, MI (US)

(21) Appl. No.: 19/451,461

(22) Filed: Jan. 16, 2026

Related U.S. Application Data
(60) Provisional application No. 63/749,880, filed on Jan. 27, 2025.

(51) Int. Cl. G10L 13/033; G10L 13/047; G10L 25/30

(52) U.S. Cl. CPC G10L 13/033; G10L 13/047; G10L 25/30

(57) ABSTRACT

A vehicular personalization system includes a communication module disposed at a vehicle equipped with the vehicular personalization system. The communication module is configured to receive messages. The vehicular personalization system, responsive to processing by an ECU of a message received by the communication module, determines a sender of the message. The vehicular personalization system, using a text to speech model, audibly provides the message to a driver of the vehicle via a speaker disposed within the vehicle. The text to speech model generates speech for the message that is representative of a voice of the sender of the message.

### CROSS REFERENCE TO RELATED APPLICATION

The present application claims the filing benefits of U.S. provisional application Ser. No. 63/749,880, filed Jan. 27, 2025, which is hereby incorporated herein by reference in its entirety.

### FIELD OF THE INVENTION

The present invention relates generally to a vehicle personalization system for a vehicle and, more particularly, to a vehicle personalization system that utilizes one or more speakers at a vehicle.

### BACKGROUND OF THE INVENTION

Use of speech to text and text to speech is common and known. For example, digital assistants may use text to speech algorithms to generate audible speech.

### SUMMARY OF THE INVENTION

A vehicular personalization system includes a communication module disposed at a vehicle equipped with the vehicular personalization system. The communication module is configured to receive messages. The system includes an electronic control unit (ECU) with electronic circuitry and associated software. The electronic circuitry of the ECU includes a data processor for processing messages received by the communication module. The ECU, responsive to processing by the data processor of a message received by the communication module, determines a sender of the message. The ECU, using a text to speech model, audibly provides the message to a driver of the vehicle via a speaker disposed within the vehicle. The text to speech model generates speech for the message that is representative of a voice of the sender of the message. These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a personalization system that includes a microphone and a speaker.

### DESCRIPTION OF THE PREFERRED EMBODIMENTS

A vehicle personalization system and/or driver or communication assist system operates to receive messages from various sources and may process the message data to audibly provide the messages to the driver of the vehicle using a text to speech model that mimics the voice of the sender of the message, such as to enhance the driver's experience and reduce distraction. The personalization system includes a text to speech processor or processing system that is operable to receive message data from one or more sources, such as a mobile device of the driver, a vehicle infotainment system, a cloud service, or the like, and to provide an output to a speaker device for delivering the messages in a synthesized voice. Optionally, the personalization system may provide feedback, such as a confirmation, a reply, a query, or the like, using the same or a different voice.

In vehicle environments, auditory interfaces typically utilize a static or generic synthesized voice to convey information from disparate sources. When a driver receives messages from different senders (e.g., a spouse, a work colleague, or an emergency alert system) delivered via a single generic voice, the driver relies solely on the semantic content of the message or a spoken preamble (e.g., "Message from John") to identify the source. This dissociation between the source of the information and the auditory delivery may increase cognitive load, as the driver performs additional mental processing to contextualize the message while operating the vehicle. The personalization system described herein addresses this by acoustically encoding the identity of the sender into the audio output. By modulating vocal characteristics (e.g., pitch, timbre, and prosody) to match the sender, the system allows the driver to identify the source of the information through distinct auditory cues. This reduces the time and cognitive effort required to process the message, thereby minimizing distraction and allowing the driver to maintain focus on vehicle operation.

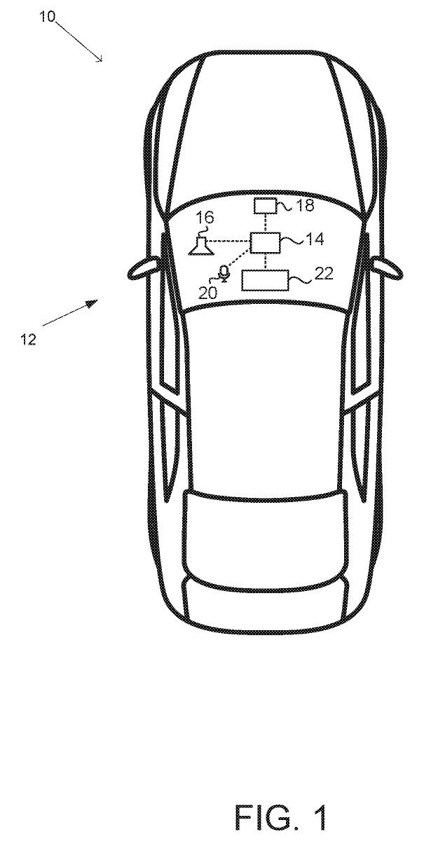

Referring now to the drawings and the illustrative embodiments depicted therein, a vehicle 10 includes a personalization system 12 that includes a text to speech model or engine 18, such as a neural network or a concatenative synthesis system. The system generates synthetic speech from text input, such as a message received from a sender via a communication network or device, such as a cellular network or a mobile device. The system may optionally include multiple text to speech models or engines, such as a model for each sender that the system has been trained to mimic, based on voice samples or features of the sender. The system produces speech output that sounds similar to the sender of the message, with the model having parameters or weights that are adjusted or optimized based on the training data or feedback (FIG. 1). Optionally, the system may also include a speech to text model or engine that converts speech input from the driver or a passenger of the vehicle into text output, such as for sending a reply message or a command to the system or another device. The system 12 includes a control or electronic control unit (ECU) 14 having electronic circuitry (e.g., memory 26) and associated software, with the electronic circuitry including a data processor or audio processor that is operable to process text or speech data received or generated by the system, whereby the ECU may select or activate the appropriate text to speech model or engine for the message sender and/or the system provides audible output at one or more speaker devices 16 for listening by the driver of the vehicle. The data transfer or signal communication from the communication network or device to the ECU or from the ECU to the speaker device may comprise any suitable data or communication link, such as a wireless connection, a vehicle network bus or the like of the equipped vehicle.

As shown in FIG. 1, the system 12 includes a model 18 that generates speech for output by the speaker(s) 16. The system 12 may include or be in communication with a communication module 24 (e.g., a transceiver, a cellular modem, or a vehicle-to-everything (V2X) communication unit) configured to receive data, such as message data, audio data, and/or model data. The model 18 may be trained by processing audio data, such as phrases or sounds spoken by the person to be impersonated or mimicked by the model 18 (i.e., the message sender). This training process involves capturing and analyzing various vocal characteristics, such as phonemes, prosody, intonation, tone, pitch, and speaking style, which are then used to adjust the parameters or weights of the model 18. By doing so, the system 12 is operable to generate synthetic speech that closely resembles the voice of the message sender by converting text from the received message into the audible output having the vocal characteristics of the sender. The model 18 may be based on various architectures, such as neural networks, recurrent neural networks (RNNs), transformer models, or concatenative synthesis systems. These architectures allow the model 18 to learn and replicate complex vocal patterns. The model 18 may execute either locally at the vehicle (e.g., on the processor of the ECU 14) or on a user's device. Alternatively, the model 18 may execute at least partially remotely on a server, which may be in wireless communication with the vehicle and/or the user device via the communication module 24. Optionally, the model 18 includes a plurality of models or several sub-models, where each model of the plurality of models is trained to mimic different voices, enabling the system 12 to switch between voices as needed based on the identified sender of the message.

The vehicle, a remote server, and/or a user device in communication with the vehicle (e.g., a mobile phone) may store different profiles in memory 26, where each profile is associated with a different message sender. These profiles may include the data required to impersonate or mimic the sender, such as voice samples, vocal characteristics, training data, and model parameters. When the system 12 receives a message (e.g., a text message via a mobile device of the driver communicated to the communication module 24), it determines who the message is from by analyzing the sender information included in the message metadata (e.g., a caller ID, a Session Initiation Protocol (SIP) header, an email address, or a contact name). Based on this determination, the system 12 selects the appropriate voice profile and/or the appropriate model from the plurality of models to use for audibly playing the message using text to speech over the speaker 16. This allows the system 12 to accurately generate synthetic speech that closely resembles the voice of the specific sender for personalized communication. In some examples, if a specific voice profile does not exist for the determined sender, the system 12 may access a cloud-based service to retrieve voice features associated with the sender or may utilize a default voice profile.

The system 12, via the communication module 24, is operable to receive messages from various sources to audibly play. Examples of these sources include text messages (e.g., SMS or MMS) from mobile devices, emails from email servers (e.g., via SMTP or IMAP), notifications from social media platforms, alerts from smart home devices, and updates from navigation systems. The user or driver may assign or select a particular voice (e.g., via the profiles) from among the trained voices to each source of messages, such that the selected voice will speak the messages from the particular source. Furthermore, in some implementations, the system 12 may interact with a vehicle navigation system. In such examples, the system 12 may output navigation instructions (e.g., turn-by-turn directions) via the speaker 16 using the text to speech model 18 such that the navigation instructions are audibly spoken in the voice of the message sender or another selected voice profile familiar to the driver.

Optionally, the system 12 includes a microphone 20 and/or a display 22 (e.g., a touchscreen of an infotainment head unit). The microphone 20 may be used to audibly receive messages and commands from the driver, such as messages replying to the message sender. The ECU 14 may process the audio received by the microphone 20 to generate a text reply. The display 22 may be used to display received messages and allow the driver to interact with the system 12, such as selecting voice profiles, associating specific voice profiles with specific message senders, and changing various settings. For example, the display 22 may present a list of recent message senders and allow the user to assign a specific neural network model or voice profile to each sender.

The system 12 optionally uses voice biometrics or voice recognition to authenticate the driver or user before allowing access to personalized settings or messages. By analyzing unique vocal characteristics, such as tone, pitch, frequency coefficients, and speaking style, the system 12 (e.g., via the processor of the ECU 14) may verify the identity of the user. This verification operates to restrict access to sensitive information and personalized features, enhancing the security and personalization of the system. To further ensure the security and privacy of the voice data and messages, the system 12 may employ cryptographic protocols. Voice data and messages may be encrypted both in transit and at rest using algorithms such as Advanced Encryption Standard (AES) or Transport Layer Security (TLS), preventing unauthorized access and ensuring that sensitive information remains confidential. In some examples, the system 12 may utilize public and private key pairs stored in the memory 26 to authenticate the communication between the vehicle and the remote server.

The system 12, in some examples, integrates or communicates with the vehicle's navigation system (e.g., via a vehicle network bus, such as a Controller Area Network (CAN) bus) to provide directions in the voice of a familiar person. This integration allows the driver to receive turn-by-turn directions generated by the text to speech model 18 in a voice that they recognize, such as the voice of the sender of a received message, enhancing the driving experience and reducing the cognitive load associated with following navigation instructions. By using a familiar voice (e.g., the voice of a spouse, a child, or a colleague), the system 12 may make the navigation process more intuitive and less stressful for the driver. Optionally, the system 12 may integrate with other vehicle systems, such as the vehicle's infotainment system, to read out song titles, artist names, metadata, or other media information in a personalized voice using the text to speech model 18.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular personalization system, the vehicular personalization system comprising:a communication module disposed at a vehicle equipped with the vehicular personalization system, the communication module configured to receive messages;an electronic control unit (ECU) comprising electronic circuitry and associated software;a speaker disposed within the vehicle;wherein the electronic circuitry of the ECU comprises a data processor for processing messages received by the communication module;wherein the vehicular personalization system, responsive to processing by the ECU of a message received by the communication module, determines a sender of the message; andwherein the vehicular personalization system, using a text to speech model, audibly provides the message to a driver of the vehicle via the speaker, and wherein the text to speech model generates speech for the message that is representative of a voice of the sender of the message.

2. The vehicular personalization system of claim 1, wherein the text to speech model is trained to generate speech that is representative of the voice of the sender of the message.

3. The vehicular personalization system of claim 2, wherein the text to speech model is trained using phrases or sounds spoken by the sender of the message.

4. The vehicular personalization system of claim 1, wherein the text to speech model comprises a neural network.

5. The vehicular personalization system of claim 1, wherein the vehicular personalization system, responsive to determining the sender of the message, selects the
text to speech model from among a plurality of models, and wherein each model of the plurality of models is associated with a different voice.

6. The vehicular personalization system of claim 1, wherein the communication module receives the message from a mobile device of the driver of the vehicle.

7. The vehicular personalization system of claim 1, wherein the communication module receives the message from a server remote from the vehicle.

8. The vehicular personalization system of claim 1, wherein the message comprises a text message.

9. The vehicular personalization system of claim 1, wherein the message comprises an email.

10. The vehicular personalization system of claim 1, wherein the vehicular personalization system, using the text to speech model, audibly provides instructions from a navigation system using a voice profile associated with the sender of the message.

11. A method of operating a vehicular personalization system, the method comprising:receiving, via a communication module disposed at a vehicle equipped with the vehicular personalization system, messages;processing, by a data processor of an electronic control unit (ECU) comprising electronic circuitry and associated software, messages received by the communication module;determining, responsive to the processing by the ECU of a message received by the communication module, a sender of the message; andaudibly providing, using a text to speech model, the message to a driver of the vehicle via a speaker disposed within the vehicle, wherein the text to speech model generates speech for the message that is representative of a voice of the sender of the message.

12. The method of claim 11, wherein the text to speech model is trained to generate speech that is representative of the voice of the sender of the message.

13. The method of claim 12, wherein the text to speech model is trained using phrases or sounds spoken by the sender of the message.

14. The method of claim 11, wherein the text to speech model comprises a neural network.

15. The method of claim 11, further comprising selecting, responsive to determining the sender of the message, the text to speech model from among a plurality of models, wherein each model of the plurality of models is associated with a different voice.

16. The method of claim 11, wherein receiving the message comprises receiving the message from a mobile device of the driver of the vehicle.

17. The method of claim 11, wherein receiving the message comprises receiving the message from a server remote from the vehicle.

18. The method of claim 11, wherein the message comprises a text message.

19. The method of claim 11, wherein the message comprises an email.

20. The method of claim 11, further comprising audibly providing, using the text to speech model, instructions from a navigation system using a voice profile associated with the sender of the message.
